(19) United States
(12) Patent Application Publication
(10) Pub. No.: US 2018/0126203 A1
(43) Pub. Date: May 10, 2018

(54) HIGH-VISCOSITY FIRE SUPPRESSANT DELIVERY SYSTEM USING AN INJECTION QUILL

(71) Applicant: Patlon Aircraft and Industries Ltd., Halton Hills (CA)

(72) Inventor: Jamie Beluse, Halton Hills (CA)

(21) Appl. No.: 15/348,557

(22) Filed: Nov. 10, 2016

(51) Int. Cl. A62C 5/00; A62C 27/00; A62C 35/68; B05B 7/24; B05B 12/00; F04C 2/14; F04C 2/12; F04C 14/08; F04C 15/00

(52) U.S. Cl. CPC A62C 5/002; A62C 27/00; A62C 35/68; B05B 7/2497; F16K 15/044; F04C 2/14; F04C 2/126; F04C 14/08; F04C 15/008; B05B 12/006

(57) ABSTRACT

A system for delivering an additive into a fluid stream is disclosed that addresses the issues of delivering a pressurized stream of a shear thickening or dilatant material which is commonly used for fire suppression. The system uses a positive displacement pump that is controlled to deliver the additive to a fluid stream in the correct ratio according to fluid flow rates. The system also incorporates an injection quill for delivering the additive to the fluid stream within a dispensing line. The injection quill includes an internal extension within its valve chamber, and the internal extension provides ports that allow for improved fluid flow of dilatant material.

### FIELD

The present disclosure relates generally to a system for delivering a fire suppressant. More particularly, the disclosure is directed to using an improved injection quill in a fire suppressant delivery system.

### BACKGROUND

Fire suppressants can have a high viscosity or be a dilatant material that allows the fire suppressant to adhere to vertical surfaces. High viscosity makes delivery of the fire suppressant difficult. A dilatant (also termed shear thickening) material is one in which viscosity increases with the rate of shear strain. Such a shear thickening fluid, also known by the acronym STF, is an example of a non-Newtonian fluid.

A shear thickening fluid is a fluid where the shear viscosity increases with applied shear stress. This behavior is only one type of deviation from Newton's Law, and it is controlled by such factors as particle size, shape, and distribution. The properties of these suspensions depend on Hamaker theory and Van der Waals forces and can be stabilized electrostatically or sterically. Shear thickening behavior occurs when a colloidal suspension transitions from a stable state to a state of flocculation. Such behavior is currently being researched for use in body armor applications by companies like Dow Corning with their Active Protection System. A large portion of the properties of these systems are due to the surface chemistry of particles in dispersion, known as colloids.

As is of course well known, the standard method of extinguishing urban fires is to spray water, usually from hoses, onto the burning buildings, etc. Water is certainly an excellent extinguisher, but it does have certain shortcomings. The most obvious of which is that, being a free-flowing liquid, it runs off vertical surfaces. To render a vertical wall sufficiently wet to be either noncombustible or at least difficult to combust, comparatively huge quantities of water must be applied to it. Additionally, the wetness which is imparted will tend to dissipate rapidly by evaporation and drain off. It obviously would be very useful if water could be modified in some fashion so as to stick to vertical surfaces and thereafter undergo comparatively limited loss by evaporation and runoff.

U.S. Pat. No. 3,719,515 teaches converging a stream of dilatant material with another solution immediately before or after dispersing, so that upon convergence a viscous dilatant fire suppressant material is formed. The converging streams are achieved using adjacent or concentric nozzles surrounding an inner nozzle. This approach avoids placing mechanical stress on the dilatant solution but does not provide adequate mixing of the dilatant material with the solvent.

U.S. Pat. No. 3,848,802 also describes disadvantages of external mixing. The latter practice does not permit sufficient contact between the molecules of the reacting solutions to convert them into the dilatant material in a highly efficient manner. Moreover, when external mixing methods are employed, unreacted droplets of the solutions which do not evaporate before reaching the substrate wet the surface thereof and reduce the tendency of the dilatant material to adhere thereto. Still further, with external mixing methods the direction and consistency of the spray of dilatant material is not easily controlled. For the above reasons, preparation and application of the dilatant material has been relatively expensive.

Injection quills can be used for injecting a substance into a moving stream of fluid, such as water. A standard injection quill has a check valve with a large needle and thread on the end so it can be screwed into a pipe and allow for injection of a material into the flow of another material. These standard quills are primarily used in water treatment plants and were designed to work with chlorine and other low viscosity materials. Standard injection quills are typically operated with around 3,000 psi injection pressure and are used to deliver corrosive chemicals.

These standard injection quills are unsuitable for delivering a high viscosity or dilatant fire suppressant. Firstly, the ports through the standard injection quill are too small and required too much power to push the highly viscous material through the quill. The injection port is typically smaller than the input port, thus creating resistance through the quill. Secondly, the check valve ball would get pushed to the bottom of the chamber and crush the spring at the bottom. Thin materials would not push the ball that far to the bottom and allow the thinner material to flow through the spring easily. Because the spring is crushed flat, it creates a strainer that is very difficult to push the material through. In addition to the increased resistance, the crushed spring would catch the larger particles suspended in the material and start to plug the quill. The longer it ran, the more particles it would catch, the more resistance in the quill and less volume would pass through. Eventually it would clog completely and jam the pump motor. Finally, a standard injection quill is made of stainless steel and is press-fit assembled. This is unacceptable for delivery of a viscous fire suppressant as the injection quill will require periodic inspection and cleaning. Disassembly of a press fit quill is impossible without destroying the ball and possibly the ball seat.

A cross-sectional view of standard prior art injection quill is shown in FIG. 1. The main body 10 and quill body 20 are connected by a press fit. Main body 10 can include threads 14, 16 on the outer surface to allow for coupling with other pipes. The interior of the main body forms a check valve chamber 30 containing a valve ball 40 and valve spring 50. In operation, fluid enters main body 10 through input port 12 and impinges upon valve ball 40 forcing valve spring 50 to compress to allow fluid to flow from input port 12 to quill body 20 through the compressed valve spring 50 and out injection port 22. As noted above, the internal diameter of injection port 22 is less than the internal diameter of input port 12 causing resistance through the injection quill. The end of injection port 22 is preferably angled so that the angled opening faces the direction of fluid flow to limit the backpressure into the injection quill.

### SUMMARY

Accordingly, there is a need for a system for delivering high-viscosity or dilatant additive material such as fire suppressants.

According to a first aspect, a system for delivering an additive into a fluid stream is disclosed that includes a positive displacement pump coupled to an additive source containing the additive. The positive displacement pump pumps the additive through an additive dispensing line into an injection quill coupled to a water dispensing line. A variable speed motor is coupled to the positive displacement pump to drive the positive displacement pump. A flow meter is coupled to the water dispensing line prior to the injection quill to determine the water flow rate which is used by a controller to control a rate of injection from the additive injecting line into the water dispensing line by controlling the variable speed motor according to the water flow rate from the flow meter.

The positive displacement pump used with the additive can be a gear pump or lobe pump to limit shocking of the dilatant material. Preferably, the fluid is water, and the fluid dispensing line can be coupled to a water pump and water tank of a fire truck or coupled to a building water supply, such as for a building fire sprinkler system. The controller can be a programmable logic controller or other microprocessor-based system, and the controller can also include a motor controller.

The injection quill should include a check valve to prevent backflow into the additive dispensing line. The check valve can have a check valve chamber, check valve ball, and a spring. The injection quill can also have an extension extending into the check valve chamber, and the spring and check valve ball can be seated axially on the extension. The extension can also define one or more apertures for providing fluid coupling between the check valve chamber and an internal passage of the injection quill to allow fluid to flow to the injection port of the quill. Some aspects can also include an inline mixer in the fluid line after the injection quill.

According to another aspect, an improved injection quill for injecting the additive into a fluid stream is disclosed. The injection quill comprises a main body having an input port for receiving the additive, and a check valve chamber formed within the main body coupled to the input port. The check valve chamber contains a valve ball biased in a closed position by a valve spring. The injection quill also comprises a quill body having an injection port for insertion into the fluid stream, and an internal extension that extends into check valve chamber, the internal extension having at least one port that couples the check valve chamber to the injection port.

The internal extension of the injection quill can provide a seat for positioning the valve spring on an end of the internal extension that is disposed within the check valve chamber. The internal extension can also have an internal diameter at least as large as an internal diameter of the input port to limit fluid resistance through the injection quill. The main body can also include threading on an inner surface that mates with threading on an outer surface of the quill body to allow for assembly and disassembly of the injection quill. A set screw can be used retain the main body and the quill body in fixed engagement. The main body can have threading on the outer surface near an output port end of the main body and threading on the outer surface near an injection port end of the main body to allow for coupling the injection quill to an additive dispensing line and a water dispensing line.

### BRIEF DESCRIPTION OF THE DRAWINGS

For a better understanding of the various embodiments described herein and to show more clearly how they may be carried into effect, reference will now be made, by way of example only, to the accompanying drawings which show at least one exemplary embodiment, and in which:

FIG. 1 is a cross-sectional view of a prior art injection quill;

FIG. 2 is a block diagram showing an embodiment of a fire suppressant delivery system;

FIG. 3 is a perspective view of an embodiment of an injection quill for use in a fire suppressant delivery system;

FIG. 4 is a top view of the injection quill of FIG. 2;

FIG. 5 is a side view of the injection quill of FIG. 2; and

FIG. 6 is a cross-section view of the injection quill of FIG. 3 along line A-A.

### DESCRIPTION OF VARIOUS EMBODIMENTS

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather merely serves to provide examples of some of the possible embodiments.

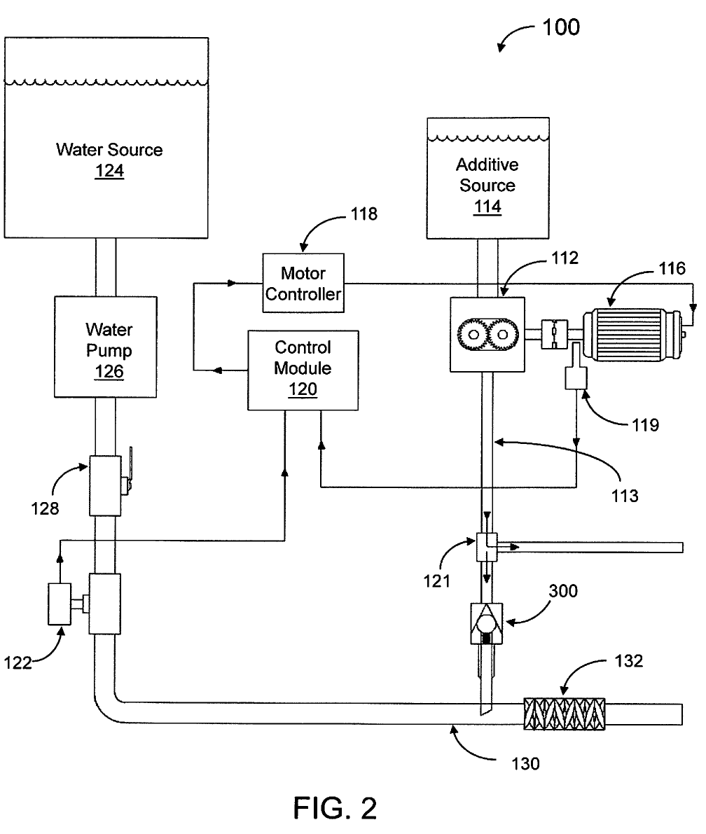

Reference is first made to FIG. 2, shown is a schematic diagram of an additive delivery system 100. System 100 can be used for delivery of dilatant fire suppressants into a fluid stream, such as water, for example. System 100 could be a standalone system that includes both a water system and an additive system, or system 100 can be configured to work with other external water supply systems, such as with a fire truck or a building fire suppression system. Fire suppressant delivery system 100 introduces a shear thickening fluid additive from additive source 114 into a water stream provided by the water system prior to delivery.

Fire suppressant delivery system 100 includes an additive pump 112 that is coupled to additive source 114 to pump the additive into additive dispensing line 113. A holding tank, reservoir, or feed system containing the additive can act as additive source 114. Additive pump 112 is selected to limit the shear thickening properties of the additive material. Preferably, a positive displacement rotary-type pump is used, such as a rotary-style gear pump, a lobe pump, or a rotary vane pump, for example. A positive displacement gear pump can provide a measurable and constant volume of additive material for each revolution of the pump. Using a positive displacement gear pump allows for a constant flow of additive at a given speed (revolutions per minute (RPM)) of additive pump 112. A piston or diaphragm pump is undesirable as it would shock the additive material causing it to thicken and make it more difficult to inject the additive into the water stream.

Additive pump 112 can be coupled to a pump motor 116, and pump motor 116 can be a variable speed motor controlled via motor controller 118 and RPM encoder 119. Control module 120 can receive the speed of pump motor 116 from RPM encoder 119 and provide output to motor controller 118 to adjust the speed of pump motor 116, and thus the flow rate of the additive being pumped from additive source 114. Control module 120 can also be coupled to a flow meter 122 that measures the flow rate of the water system (e.g. a paddle wheel flow meter). This allows control module 120 to control the ratio of water to additive by increasing or decreasing the speed of additive pump 112 based on the water flow rate from flow meter 122. In some embodiments, RPM encoder 119 and motor controller 118 can be integrated into pump motor 116. Other embodiments, can integrate the functionality of RPM encoder 119, motor controller 118, and pump motor 116 directly with additive pump 112.

Additive dispensing line 113 can include a calibration valve 121 that can direct the additive to a calibration port to allow control module 120 to determine the volume of additive supplied per revolution of pump motor 116. Preferably, calibration is performed prior to operation of additive delivery system 100.

Additive pump 112 can be driven by either an AC or a DC motor. Pump motor 118 is preferably using low speeds between 0 and 1800 RPM, and is preferably a low horsepower motor, such as a ¾ or 1 horsepower motor. In some embodiments, a programmable logic controller (PLC) can act as control module 120 coupled to RPM encoder 119. In other embodiments control module 120 can include other microprocessor-based controllers.

Motor controller 118 can be a variable-frequency drive or DC drive (voltage regulator) that can be coupled to control module 120 to control the speed of additive pump 112. Motor controller 118 can work with either a DC or AC pump motor 116. Motor controller 118 can vary the frequency or voltage, depending on the motor type, to control the speed of pump motor 116. Motor controller 118 can have a resistive compensation feature that allows motor controller 118 to maintain a constant speed regardless of the resistance to pump motor 116 from additive pump 112. As water pressure fluctuates in output water dispensing line 130, it can become easier or harder to inject the additive fire suppressant material. Motor controller 118 can compensate for the fluctuation in water pressure to maintain the proper injection rate of additive into output water dispensing line 130.

Pump motor 116 can be a permanent magnet DC motor that can be powered by a 12 Volt DC source. This may be preferable for a vehicle mounted or mobile fire suppressant delivery system 100 that includes a 12 Volt battery and alternator. In some embodiments, a gearbox can be used to couple pump motor 116 to additive pump 112. For example, a 3 to 1 gearbox can be used to limit the speed of pump motor 116 to a maximum of 600 RPM. A person skilled in the art can select the amount of displacement in additive pump 112, the RPM of pump motor 116, the horsepower of pump motor 116, and the gear ratio in order to obtain the desired mix ratio of the additive with the water.

A water system supplies a water stream to the additive system. The water system can include a water source 124, such as a reservoir, holding tank, or connection to a city/municipal/building water supply (e.g. a hydrant, stand pipe, etc.). An unpressurized water source 124 will require a water pump 126 to pressurize the water stream. A shut-off valve 128 can be included in the water system to start or stop the water supply. Shut-off valve 128 can be integrated with water pump 126. Although water is used in the examples provided, it should be understood by a person skilled in the art that other fluids can be used.

An injection quill 300 is coupled to additive dispensing line 113 which is used to inject the additive directly into output water dispensing line 130. Injection quill 300 is positioned so that the output port is positioned near the center of output water dispensing line 130 to deposit the additive material near the center of the water flow. Injection quill 300 also includes a check valve to prevent back flow of water from the water system into the additive system. Injection quill 300 can also maintain the 3/4 National Pipe Thread (NPT) thread standard for screwing injection quill 300 into the receiving water pipe. This allows much more flow of the high viscous material and requires less power to do so without having to change the receiving pipe size.

Some embodiments can also include an inline static mixer 132 coupled in-line with output water dispensing line 130 after injection quill 300 that can help mix the additive with water before dispensing the mixture. The need for using an inline static mixer will depend on the material properties of the additive.

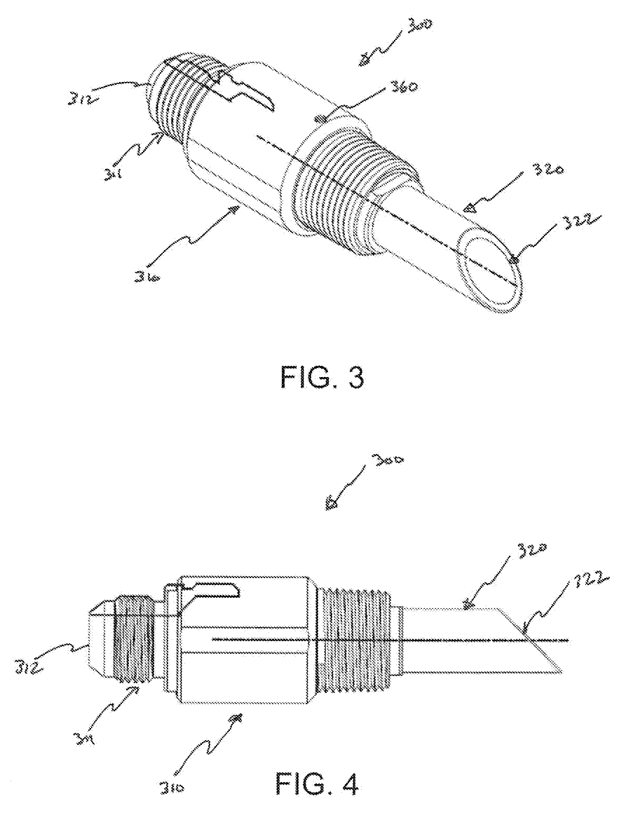

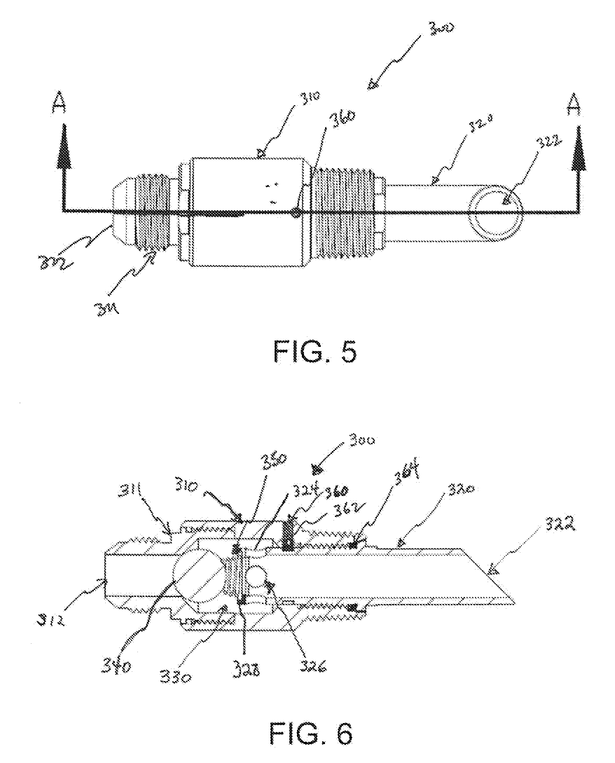

Referring now to FIGS. 3-6, an injection quill 300 that is improved over prior art injection quills for delivering viscous or dilatant fluids is illustrated in further detail. Injection quill 300 has a tubular main body 310 and a tubular quill body 320 that fits within main body 310. Injection quill 300 provides an improved fluid passage through the use of one or more ports 326, as best illustrated in the cross-sectional view in FIG. 6. Ports 326 are located on an internal extension 324 of quill body 320. Internal extension 324 extends into the check valve chamber 330 that is formed within main body 310.

In operation, fluid enters input port 312 of main body 310 and impinges upon valve ball 340 forcing valve spring 350 to compress. A seat 328 can be machined into the end of internal extension 324 to fit with valve spring 350. When valve ball 340 moves and forces valve spring 350 to compress towards seat 328, fluid enters check valve chamber 330 and the fluid flows through one or more ports 326 located on internal extension 324 and through quill body 320 out injection port 322.

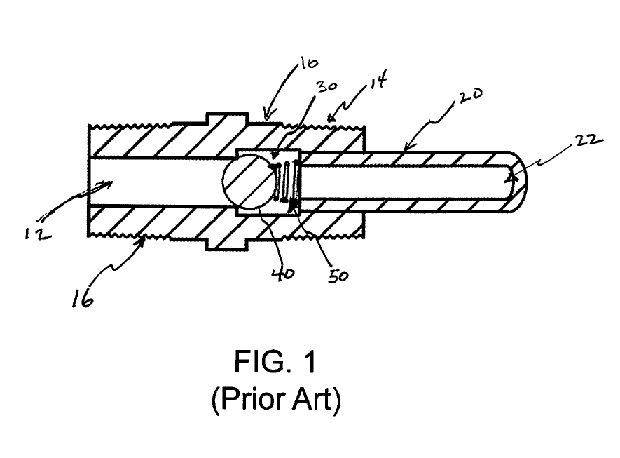

The end of internal extension 324 having seat 328 can be open or closed to interior of quill body 320. A closed end design forces all fluid to flow through ports 326. Internal extension 324 should be designed such that there are a sufficient number of ports 326 and ports 326 are of a sufficient size to allow the desired additive material flow through injection quill 300 with low resistance. Use of ports 326 provides much less fluid resistance than forcing fluid to flow through valve spring 50 of prior art injection quill in FIG. 1.

In the embodiment illustrated in FIGS. 3-6, internal extension 324 has four ports 326 that each have a 0.25 inch diameter which provides 0.196 square inches of total area open area for fluid to pass from main body 310 through internal extension 324 to injection port 322. Internal diameter of injection port 322 is also preferably similar to the internal diameter of input port 312 of main body 310. This also provides for less fluid resistance in comparison to the prior art injection quill of FIG. 1. The embodiment shown in FIGS. 3-6 has an internal quill body 320 diameter of 0.5 inches and an internal input port 312 diameter of 0.5 inches. Internal quill body and input port diameters provides a similar throughput to ports 326 (i.e. a similar surface area of 0.196 square inches).

Main body 310 includes two sets of threading on its outer surface that is used to couple injection quill 300 into a system. The first set of threading near the input port end of main body 310 is used to couple to a pipe, hose, or tubing that supplies the additive material. The second set of threading near the injection port end of main body 310 is used to couple injection quill 300 to the vessel containing the fluid flow that will be supplied with the additive.

Another advantage of injection quill 300 over prior art injection quills is that it can be disassembled easily to be cleaned. Main body 310 includes threading on its inner surface that mates with threading on the outer surface of quill body 320. This allows quill body 320 to be screwed or unscrewed from main body 310 for assembly or disassembly to facilitate cleaning of injection quill 300. Main body 310 can include a set screw aperture 362 for receiving a set screw 360 to retain main body 310 and quill body 320 in position and prevent unscrewing of quill body 320 in operation. Injection quill 300 can also include a sealing ring 364 to prevent leaks between main body 310 and quill body 320.

In some embodiments, main body 310 can include an input port body 311 that can be removed from main body 310. Threading on the outer surface of input port body 311 mates with threading on the inner surface of main body 310 to allow input port body 311 to screwed or unscrewed from main body 310 for assembly or disassembly.

Main body 310 and quill body 320 can have reduced wall thickness of the entire quill relative to prior art injection quills. This can allow for an increase of the internal diameter of injection quill 300 from the prior art injection quill diameter of 0.308″ to an enlarged diameter 0.528″ without changing the overall external dimensions.

While the exemplary embodiments have been described herein, it is to be understood that the invention is not limited to the disclosed embodiments. The invention is intended to cover various modifications and equivalent arrangements included within the spirit and scope of the appended claims, and scope of the claims is to be accorded an interpretation that encompasses all such modifications and equivalent structures and functions.

1. A system for delivering an additive into a fluid stream, the system comprising:
a positive displacement pump coupled to an additive source containing the additive, the positive displacement pump to pump the additive through an additive dispensing line into an injection quill coupled to a fluid dispensing line;
a variable speed motor coupled to the positive displacement pump to drive the positive displacement pump;
a flow meter coupled to the fluid dispensing line prior to the injection quill to determine the fluid flow rate; and
a controller coupled to the flow meter and the variable speed motor to control a rate of injection from the additive injecting line into the fluid dispensing line by controlling the variable speed motor according to the fluid flow rate from the flow meter.

2. The system of claim 1 wherein the injection quill comprises a check valve to prevent backflow into the additive dispensing line.

3. The system of claim 2 wherein the check valve comprises a check valve chamber, check valve ball, and a spring.

4. The system of claim 3 wherein the injection quill comprises an extension extending into the check valve chamber, the spring and check valve ball seated axially on the extension.

5. The system of claim 4 wherein the extension defines at least one aperture providing fluid coupling between the check valve chamber and an internal passage of the injection quill.

6. The system of claim 1 wherein the fluid dispensing line comprises an inline static mixer after the injection quill.

7. The system of claim 1 wherein the positive displacement pump is a gear pump.

8. The system of claim 1 wherein the positive displacement pump is a lobe pump.

9. The system of claim 1 wherein the additive injecting line comprises a check valve to prevent back flow into the additive injecting line.

10. The system of claim 1 wherein the fluid dispensing line is coupled to a water pump and water tank of a fire truck.

11. The system of claim 1 wherein the fluid dispensing line is coupled to a building water supply and the water dispensing line feeds a building fire sprinkler system.

12. The system of claim 1 wherein the controller comprises a programmable logic controller and a motor controller coupled to the motor.

13. An injection quill for injecting an additive into a fluid stream, the injection quill comprising:
a main body having:
an input port for receiving the additive;
a check valve chamber formed within the main body coupled to the input port, the check valve chamber containing a valve ball biased in a closed position by a valve spring; and
a quill body having:
an injection port for insertion into the fluid stream;
an internal extension that extends into check valve chamber, the internal extension having at least one port that couples the check valve chamber to the injection port.

14. The injection quill of claim 13 wherein the internal extension provides a seat for positioning the valve spring on an end of the internal extension disposed within the check valve chamber.

15. The injection quill of claim 13 wherein the internal extension has an internal diameter at least as large as an internal diameter of the input port.

16. The injection quill of claim 13 wherein the main body has threading on an inner surface that mates with threading on an outer surface of the quill body to allow for disassembly.

17. The injection quill of claim 16 wherein the main body has a set screw aperture for receiving a set screw to retain main body and quill body in fixed engagement.

18. The injection quill of claim 13 wherein the main body has threading on the outer surface near an output port end of the main body and threading on the outer surface near an injection port end of the main body, the threading for coupling the injection quill to an additive dispensing line and a water dispensing line.
